(19) United States
(12) Patent Application Publication
(10) Pub. No.: US 2012/0210928 A1
(43) Pub. Date: Aug. 23, 2012

(54) PROTECTIVE DEVICE FOR A BOAT AND METHOD OF USING SAME

(76) Inventors: Cato Jansen, Hundvag (NO); Alf Egil Stensen, Stavanger (NO)

(21) Appl. No.: 13/499,200

(22) PCT Filed: Sep. 28, 2010
(86) PCT No.: PCT/NO10/00353

§ 371 Date: May 10, 2012

(30) Foreign Application Priority Data
Sep. 29, 2009 (NO) 20093075
May 12, 2010 (NO) 20100690

(51) Int. Cl. B63B 17/02; A62C 3/10; B60H 1/34; E04H 15/20; B63J 2/02

(52) U.S. Cl. 114/361; 454/78; 454/75; 169/46

(57) ABSTRACT

A protective device for a boat which is floating in a water or is placed on land and a method of using same are described, the protective device including a top portion which is formed by a cloth-like material and which is bounded by a border area, the border area being arranged to be brought into substantially sealing contact with an adjacent portion in order thereby to provide a space defined by the adjacent portion and the top portion, and the top portion being included at least as part of or being connected to a supporting device to be able to carry at least a portion of the top portion in a distended position, the supporting device being activatable by means of a gas.

The present invention relates to a device for and a method of protecting a boat. More particularly, it relates to a protective device for a boat which is floating in a water or is placed on land, the protective device including a top portion formed by a cloth-like material defined by a border area.

The invention is provided in different embodiments which are all directed towards the protection of pleasure boats. Some embodiments are directed towards a boat which is placed in storage on land or which is floating in water but has a reduced frequency of use. Other embodiments are directed towards one or more boats that are floating in water and that have a high frequency of use, for example several times weekly.

In particular during the winter season it may be desirable to protect a boat from precipitation and wind whether it is floating in water or is placed in storage on land. This may be done by covering the boat with a tarpaulin or other provisional devices, or the boat may be placed in a building either on water or on land. It may also be desirable to protect the boat throughout the year from contaminants like airborne particles and bird droppings and from sunlight.

So-called boathouses of the kind in which the boat is placed floatingly under a superstructure provide good protection against precipitation and wind. This is particularly true when the boathouse is provided with a closable opening. However, such buildings are expensive. In addition, in many countries, permission from the authorities is required in order to erect such permanent buildings, which is very hard to get in many places. Because of that, only a very limited number of boathouses are available, and boathouses are therefore not a real alternative for the great majority of boat owners.

From the publication NO 165532 B a floating boathouse which has the form of a floatable cover is known. The cover is shaped and dimensioned to have a relatively tight fit around the boat which it is to accommodate. The cover is provided with a closable opening through which the boat may be moved in. The boathouse is provided with mooring means which secure the boathouse and thereby the boat to a so-called mooring finger, for example. It is also proposed to provide the boathouse with a drainage pump to drain the water from the boathouse so that the boat is stored dry.

The boathouse according to NO 165532 B solves several of the drawbacks related to protecting a pleasure boat placed in storage from the elements and from contaminants.

However, there are some drawbacks relating to the cover according to NO 165532.

It is proposed in NO 165532 that the cover be formed with a relatively tight fit against all sides of the boat. This will mean that each cover must be “tailored” to the individual boat, which may entail relatively large costs. In addition, a tight-fitting cover could cause limited or poor air circulation between the boat and the cover, which could induce condensation problems with subsequent moisture damage. The biggest drawback is probably related to the fact that the cover must be formed of a relatively robust material to maintain the desired shape.

The fact that the boathouse is formed with a relatively tight fit will mean that it will not be possible for a person to stay between the outside, for example the deck, of the boat and the cover. Thus, the boat must be moved out of the cover if maintenance is to be carried out on the boat. Thereby the advantages of the boathouse cannot be utilized if the boat is going to receive surface treatment and it at the same time is a desire to have protection against dust or precipitation, for example.

A corresponding set of problems is common when a tarpaulin is used, which is lashed tightly around the entire or portions of the boat. Such a wrapping of the boat may also lead to moisture problems because of inadequate ventilation. To reduce such moisture problems or if work space is to be provided between the tarpaulin and the boat, a supporting structure which is arranged to support the tarpaulin at the desired distance from the boat has to be built.

From the publication U.S. Pat. No. 5,138,963 a U-shaped dock is known, which is provided with a bottom portion. The bottom portion is constituted by a flexible and watertight material which is attached to and hangs down from the internal periphery of the dock. In the publication is also suggested a top portion to provide a protective roof for a boat which is placed in the dock. The top portion is attached to the dock independently of the bottom portion. Thus, the top portion and the bottom portion are both dependent on being attachable to the dock.

In the Norwegian patent application NO 20093075, the present applicant proposes a protective device for a boat which is floating in a water, the protective device including: a bottom portion which is arranged to be placed floatingly on or submerged in the water under the hull of the boat; and a top portion which is joined to the bottom portion. The top portion is formed by a cloth-like material and is included at least as part of or is connected to a supporting device to be able to carry at least a portion of the top portion in a distended position.

In the Norwegian patent application NO 20093075 is also proposed a method of providing a protective device for a boat on a water, in which a bottom portion of the protective device is placed floatingly on or submerged in the water, and a top portion which is connected to the bottom portion is placed over at least a portion of the boat, the method including supplying an activatable supporting device, which is included in the top portion, with a gas at overpressure in order thereby to be able to support at least a portion of the top portion in a distended position.

The protective device according to NO 20093075 remedies the drawbacks related to the prior art as indicated above in a very satisfactory way.

However, the applicant has seen that there may be a need for a protective device which has many of the advantages that are achieved by using the protective device according to NO 20093075 but which is also suitable to be used for boats which are in storage on land or which are floating in a water and which have no need for the bottom portion.

The invention has for its object to remedy or reduce at least one of the drawbacks of the prior art, or at least to provide a useful alternative to the prior art.

The object is achieved through features which are specified in the description below and in the claims that follow.

According to a first aspect of the present invention, a protective device is provided for a boat floating in a water or being placed on land, the protective device including a top portion which is formed by a cloth-like material which is defined by a border area, the border area being arranged to be brought into substantially sealing contact with an adjacent portion in order thereby to provide a space defined by the adjacent portion and the top portion, and the top portion being included at least as part of or being connected to a supporting device to be able to support at least a portion of the top portion in a distended position, the supporting device being activatable by means of a gas.

The advantages of using a cloth-like material are several. Among other things, a cloth will be flexible when affected by external forces, it has a relatively low weight and it can be packed up when not in use. In addition, the gas which activates the supporting device will not represent any physical obstacle in the space defined between the supporting device and the distended protective device.

For a boat floating in the water the adjacent portion may be formed by a water surface. The protective device may then provide an oblong, partially dome-like body which is resting on the water surface or has a border area which is submerged in the water. It may thus be claimed that in this embodiment the water surface constitutes a portion or a demarcation of the protective device.

In an alternative embodiment, the adjacent portion may be formed by a foundation which carries the boat when this has been brought out of the water. The foundation may be on land, for example, and may be any completely or partially solid base. The protective device may then provide an oblong, partially dome-like body bearing against the foundation.

In a further alternative embodiment, the adjacent portion may be formed by a portion of the boat. The portion of the boat may be constituted by, for example, the hull of the boat, the gunwale of the boat or a portion of a possible superstructure of the boat. In this embodiment the protective device can be used both for boats floating in a water and for boats that are placed out of the water, for example on land or on a carrying body floating in the water.

It is an advantage if the protective device is provided with at least one closable opening so that the boat is brought out is of and into the protective device without the protective device having to be removed and/or that personnel may easily move between the outside and inside of the protective device.

The gas may be air, for example, which is filled into the activatable supporting device.

The gas which is filled into the activatable supporting device has a pressure which is higher than the pressure outside the activatable supporting device.

In one embodiment, the activatable supporting device is constituted by one space which is defined by the protective device and the adjacent portion. In such an embodiment, the activatable supporting device will be “punctured” when at least one of the at least one closable opening is open.

To provide an activatable supporting device which is independent of whether the closable opening is open or not, the activatable supporting device is constituted, in one embodiment, by several elongated channels arranged in connection with the top portion.

In one embodiment, the elongated channels may be formed by flexible tubes which are arranged to be filled with a gas.

In one embodiment, the activatable supporting device is constituted by a double cloth which is arranged to form one or more spaces.

In one embodiment, the activatable supporting device is constituted by a combination of two or all of the above-supporting devices.

By providing the supporting device of the protective device exclusively by means of one or more of the above-mentioned activatable supporting devices, the protective device may easily be folded up after the gas in the supporting devices has been equalized with the pressure outside the supporting devices. During the folding-up, it must be possible for the gas to be communicated out of the supporting device.

In one embodiment, the top portion is further provided with one or more mechanical supporting elements which are arranged to support at least a portion of the top portion in a distended position independently of the activatable supporting device. An example of a mechanical supporting element which may be suitable is an elongated rod element. It is an advantage if the rod element is elastically flexible.

The protective device may be provided with buoyancy means which are arranged to carry the protective device on the water. The buoyancy means may be placed in connection with the border area or it may be arranged above this, so that the border area or a skirt which is arranged free-hangingly from a portion of the top portion could be submerged in the water.

The latter solution could provide very good sealing between the protective device and the water surface.

A skirt like that, hanging freely down from a portion of the top portion, could also be arranged on a protective device which is made to be used for a boat which is placed in storage on land, for example. The skirt may, but does not have to, extend down to the foundation. The main purpose of the skirt is to provide a physical barrier between the hull of the boat and the environment on the outside of the protective device.

In one embodiment, the protective device is provided with mooring openings so that the moorings of a boat floating in a water can be passed through the openings substantially independently of the protective device. This has the advantage of loads from the boat being transmitted directly to a landing stage, for example, or another mooring point, and not by way of the protective device. The protective device may thereby be dimensioned weaker, in terms of strength. Because of the through-going moorings, the protective device and the boat can, to a certain degree, be moved independently of each other.

In a second aspect of the invention, a method of providing a protective device for a boat floating in a water or placed on land is provided, the protective device including a top portion formed by a cloth-like material defined by a border area, the top portion being placed over at least a portion of the boat, wherein the method includes placing the border area in substantially sealing contact with an adjacent portion and supplying an activatable supporting device included in the top portion with a gas at overpressure, in order thereby to support at least a portion of the top portion in a distended position.

Further features will appear from the dependent claims 16-17 and from the description that follows.

In what follows is described an example of a preferred embodiment which is visualized in the accompanying drawings, in which:

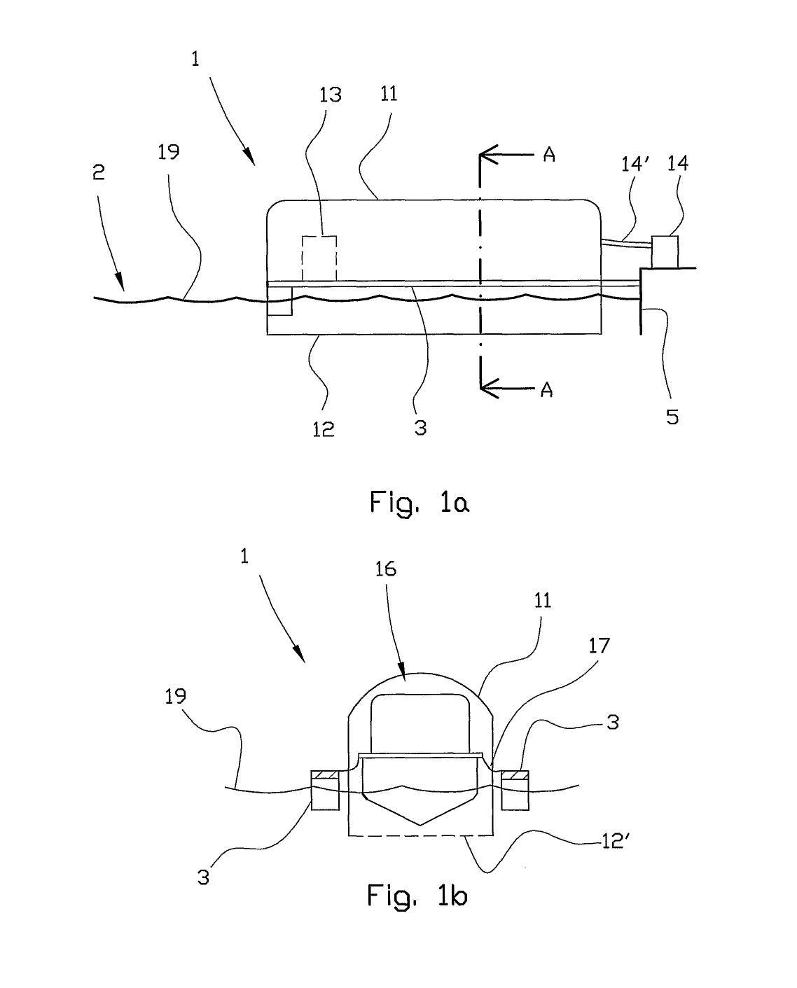

FIG. 1a shows a side view of a protective device according to the present invention, the protective device being placed on a water;

FIG. 1b shows a cross-sectional view of the protective device shown in FIG. 1a, viewed through A-A, the protective device housing a boat;

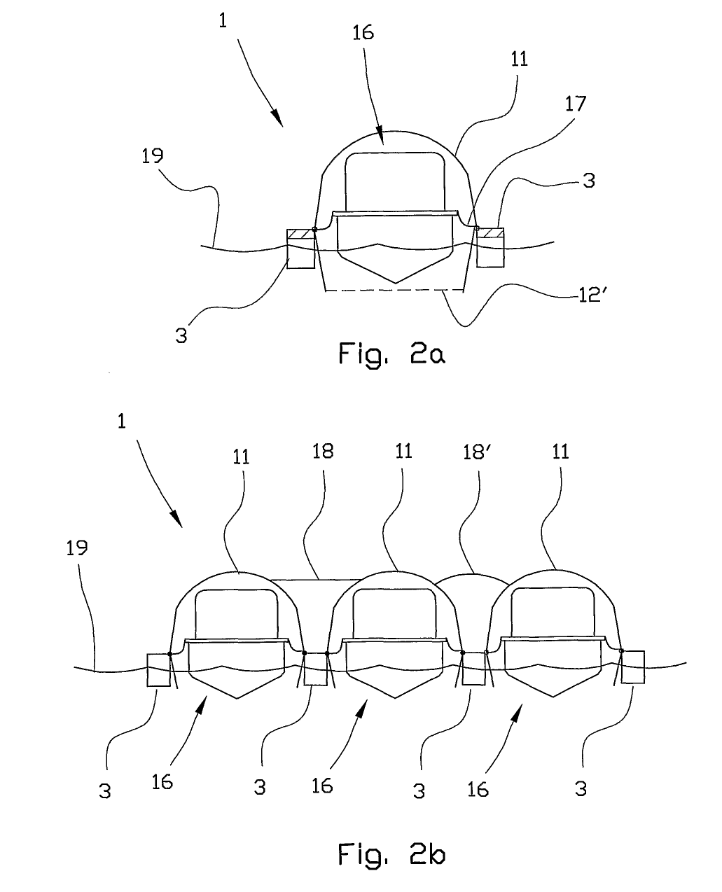

FIG. 2a shows an alternative embodiment of the protective device shown in FIG. 1b, but in which the protective device is attached to mooring fingers;

FIG. 2b shows, on a smaller scale, three protective devices resembling those shown in FIG. 2a which are placed side by side, the protective devices being interconnected at a top portion;

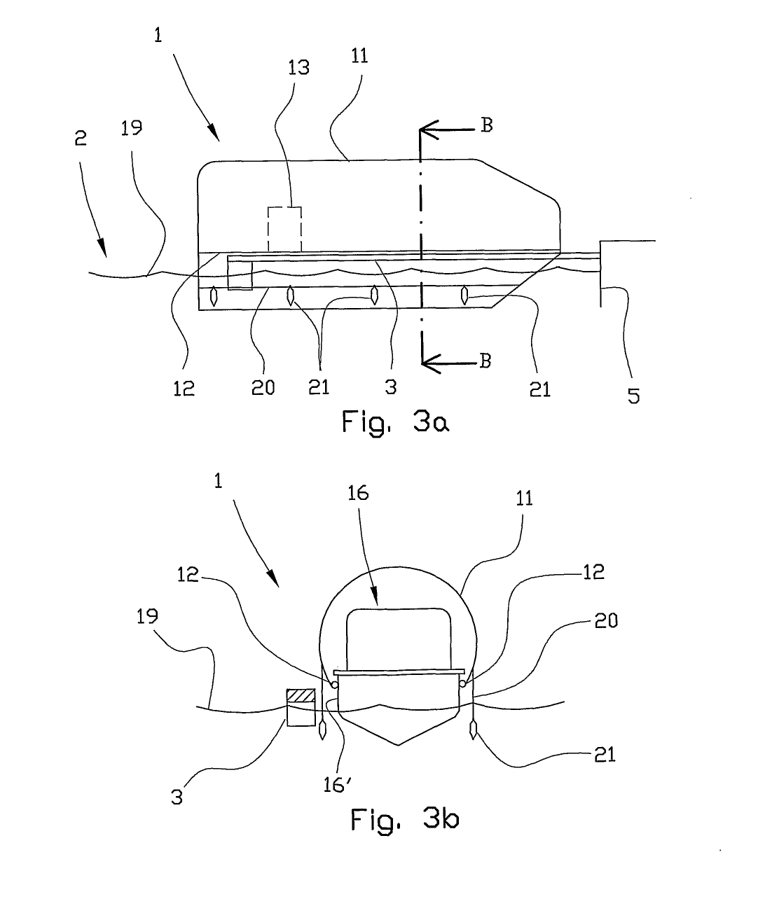

FIG. 3a shows a side view of a protective device which is provided with a skirt extending from a portion of the protective device into the water;

FIG. 3b shows a cross-sectional view of the protective device shown in FIG. 3a viewed through B-B;

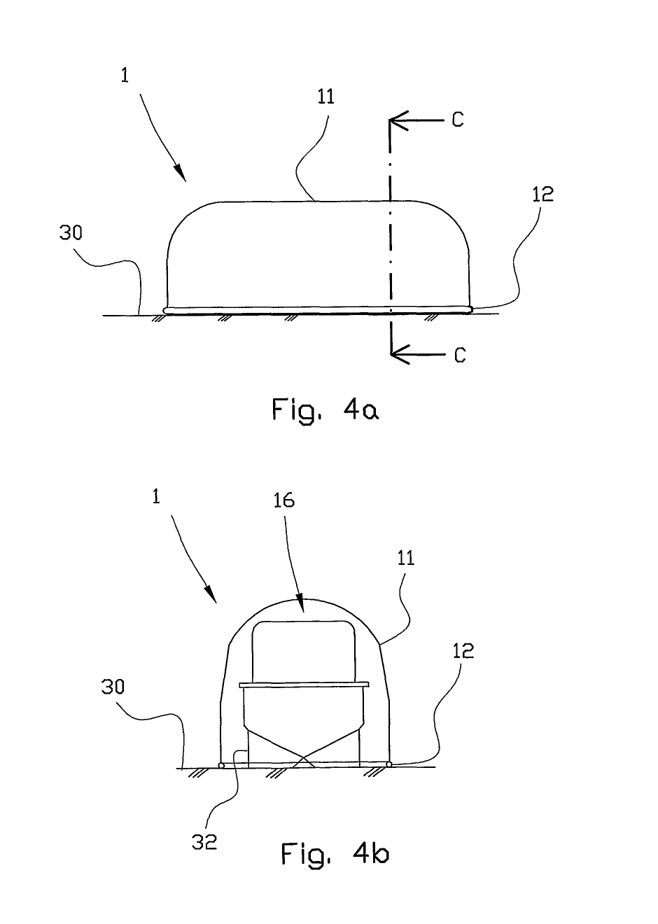

FIG. 4a shows a side view of a protective device according to the present invention, the protective device being placed on land;

FIG. 4b shows a cross-sectional view of the protective device shown in FIG. 4a viewed through C-C, the protective device housing a boat; and

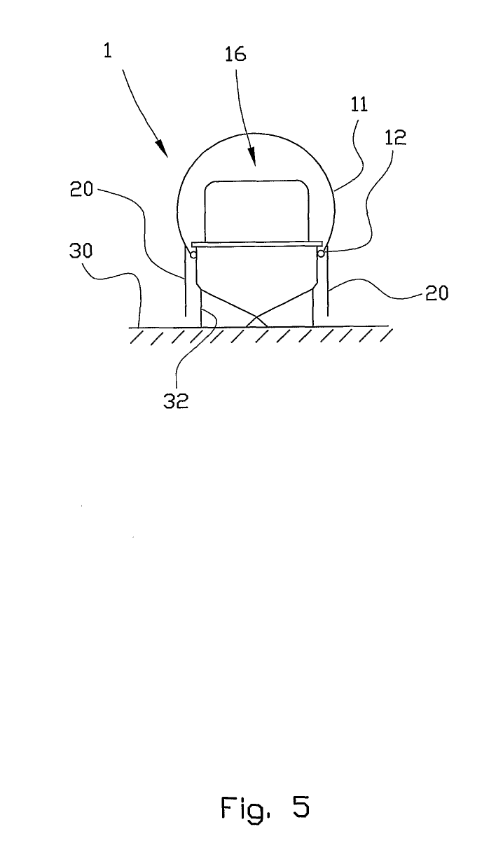

FIG. 5 shows the protective device of the kind that is shown in FIG. 3b, but where the protective device is protecting a boat which is placed in storage on land.

In the figures, like or corresponding elements are indicated by the same reference numerals.

Positional specifications such as “over” and “under” refer to relative positions that are shown in the figures.

In the figures, the reference numeral 1 indicates a protective device according to the invention.

The protective device 1 includes a top portion 11 constituted by a cloth-like material. The top portion 11 is defined by a border area 12.

The border area 12 is arranged to be brought into contact with an adjacent portion which, together with the protective device 1, can provide a closed space. The closed space or the activatable supporting device therein is arranged to contain a gas, for example air, which has a higher pressure than the air pressure surrounding the protective device 1. The higher pressure in the closed space or the activatable supporting device will make the protective device 1 be kept in a distended position.

In FIGS. 1a and 1b is shown a protective device 1 in accordance with one embodiment of the present invention. The protective device 1 is placed between two mooring fingers 3. The mooring fingers 3 are secured to a quay 5 in a manner known per se.

In what follows, the protective device 1 will also be referred to as a boathouse 1.

The boathouse 1 is formed as an elongated body in which the top portion 11 forms a partially dome-like body with a border area 12 which is submerged in a sea 2. Here, a water surface 19 of the sea 2 constitutes the above-mentioned adjacent portion.

By supplying air, for example, from an outside and in through an opening in the top portion 11, the top portion 11 will be inflated and may be kept in a distended position as shown in FIG. 1a and FIG. 1b.

The air may be supplied to the internal space of the boathouse 1 by means of an air-supplying device 14 and an associated line 14′. In order to avoid extending the line 14′ through the top portion 11, the line 14′ may alternatively, but not shown, be extended under the border area 12 into the space. The air-supplying device 14 could also be fixed to a portion of the top portion 11 and carry air in through an opening therein. The line 14′ will not be necessary then.

Alternatively, but not specifically shown, the top portion 11 may be provided with inflatable channels or tubes into which the air may be carried, so that the channels form at least a portion of the supporting device of the top portion 11. In one embodiment the channels may be provided with openings which are arranged to communicate air supplied to the channels further into said space. Air that is supplied to the channels will then first inflate the channels, and then said space. Alternatively, the channels and the space may be supplied with air independently of each other.

In FIG. 1b the boathouse 1 is shown floating freely both relative to a boat 16 which is inside the boathouse 1 and relative the mooring fingers 3 to which the boat 16 is secured by means of mooring means 17. The mooring means 17 extend through relatively tight-fitting openings (not specifically shown) in the top portion 11 so that air leakage out of the boathouse 1 is reduced to the greatest degree possible.

Alternatively to the openings, the moorings 17 may extend via the top portion 11 so that a first mooring means 17 extends between the mooring finger 3 and an outside of the top portion 11, and a second mooring means 17 extends between the boat 16 and an inside of the top portion 11.

To be able to provide sufficient overpressure in the boathouse 1 for this to be brought into and kept in a distended position, a person skilled in the art will of course understand that the amount of air supplied must exceed the overall air leakage from the boathouse 1. In-situ tests have shown that an air-supplying device 14 with a motor of 100 watts is sufficient to keep a protective device 1 for a boat 16 of a size in the order of 25 feet in a distended position.

It may be an advantage if at least one portion of the top portion 11 is provided with a closable opening 13 to facilitate access to the interior of the boathouse 1 from an outside.

As the protective device 1 shown in FIG. 1b is being filled with air, it may be kept balanced with respect to how it is floating in the sea 2. However, it may be an advantage to provide the portion of the top portion 11 which is in the water surface with buoyancy means. This embodiment is not shown in the figures but will be particularly relevant if the boathouse 1 is placed free-floatingly (without mooring fingers 3) and attached to a mooring point. Also, it may be an advantage if at least part of the portion of the top portion 11 which is submerged in the sea 2 is formed by or provided with sinkers or weights (not shown) which keep the submerged portion in a substantially vertical position. Alternatively or additionally, the border area 12 may be formed by or connected to sinkers or weights.

It may be a further advantage if the protective device 1 is provided with means 12′ (shown dashed) keeping the border areas 12 on either side of the boat 16 apart at a substantially constant distance. In such a solution, it is an advantage if the border area 12 extends below the lowermost point of the boat 16 so that the spacing means 12′ will not touch the boat 16.

In FIG. 2a is shown an alternative embodiment of the protective device 1 shown in FIG. 1b. A portion of the top portion 11 is secured to the mooring fingers 3. In this embodiment there will be no need for the buoyancy means mentioned above, but it may be an advantage if the submerged portion is kept in a vertical position by means of sinkers or weights as described above.

In FIG. 2b is shown, on a smaller scale, three protective devices or boathouses 1 resembling the boathouse 1 shown in FIG. 2a, the boathouses 1 being placed side by side. Between the upper portions of two adjacent boathouses 1 is arranged a roof element 18, 18′. The purpose of the roof element 18, 18′ is both to provide a roof over the mooring fingers 3 so that they are protected from precipitation, and to provide a mutual bracing connection between two adjacent boathouses 1.

Two variants of the roof element 18, 18′ are shown. To the left in FIG. 2b, the roof element 18 has been extended between two top portions 11 and attached to them by means of means known per se. To the right in FIG. 2b, the roof element 18′ is supported by means of bows (not shown) which are attached to holder elements (not shown either) secured to the top portion 11. The bows may be formed by elastic rods, for example, of a kind known per se.

The roof element 18, 18′ may with advantage, but does not have to, be provided with recesses in a transition portion at the top portion 11, for example. The purpose of the recesses is to allow water to be drained along the external surface of the top portion 11 into the sea. Alternatively or additionally, the roof element 18, 18′ may be arranged with a slope relative to the longitudinal direction of the boathouse 1.

In the embodiment shown, the roof element 18, 18′ does not define a closed space.

To make it easier to move the boat 16 into and out of the boathouse 1, it is an advantage if the boathouse 1 shown in FIG. la is provided with a closable opening at a rear portion (to the left in FIG. 1a).

It is further an advantage if a side portion of the boathouse 1 is provided with a closable opening 13 so that persons may easily move between the inside and outside of the boathouse 1.

FIGS. 3a and 3b show an alternative embodiment of the protective device 1 in which the border area 12 abuts against the hull 16′ of the boat 16. Thus, the hull 16′ constitutes said adjacent portion. In principle, the protective device 1 shown in FIG. 3a and FIG. 3b functions in the same way as the protective device or boathouse 1 shown in figures la and lb in which the water surface 19 constitutes the adjacent portion instead of the hull 16′ of the boat 16.

The border area 12 may be brought to abut against the hull 16′ by means of any suitable means, such as, but not limited to, a rope, an elastic band or an adhesive.

When the adjacent portion is formed by a relatively solid material, it is an advantage if the border area 12 is formed of a soft, flexible material which is arranged to take the shape of the adjacent portion. This is for any leakage of air, for example, between the adjacent portion and the border area 12 to be as little as possible.

To protect the part of the hull 16′ of the boat 16 that is not enclosed by the top portion 11 from sunlight and other external influences, the protective device 1 is provided with a skirt 20 which hangs down from a portion of the top portion 11. In the embodiment shown, the skirt 20 is provided with weights 21 so that the skirt 20 is kept in a substantially vertical position.

The skirt 20 may extend around the entire boat 16 or only around a portion of it. Even though, in the embodiment shown, the skirt 20 extends below the water surface 19, it should be understood that in an alternative embodiment, the skirt 20 may have its free end portion above the water surface 19.

FIG. 4a and FIG. 4b show a protective device 1 for a boat 16 placed in storage on land. In the embodiment shown, the border area 12 is placed against a foundation 30 which carries or supports the boat 16 by means of so-called cradles 32. In the embodiment shown, the foundation 30 forms the adjacent portion. The foundation 30 may be formed by a solid surface, earth or a floating device.

The foundation 30 shown in FIG. 4a and FIG. 4b has the same function with respect to defining the internal space of the protective device 1 as the water surface 19 has in the embodiment shown in FIG. 1a and FIG. 1b.

The protective device 1 shown in FIG. 4a and FIG. 4b may be of a construction corresponding to that explained in the discussion of FIG. 1a and FIG. 1b but adapted for use on the solid foundation 30.

FIG. 5 shows a further alternative embodiment of a protective device 1 for a boat 16 placed in storage on land.

The boat 16 is placed in cradles 32 which carry or support the boat 16 against a foundation 30.

In the embodiment shown, the border area 12 is placed against the hull 16′ of the boat 16 in a manner corresponding to that explained in the discussion of FIG. 3a and FIG. 3b.

A skirt 20 extends down from a portion of the top portion 11 but not all the way down to the foundation 30. In a manner corresponding to that of the skirt shown in FIG. 3b, the skirt 20 shown in FIG. 5 may be provided with weights (not shown) to keep the skirt in a substantially vertical position. Alternatively, the end portion of the skirt 20 may be directly or indirectly secured to the foundation 30, for example by means of a rope (not shown).

The top portion of the boathouse 1 may be provided with several channels (not shown) extending parallel to the longitudinal direction of the boathouse 1 and perpendicularly to the longitudinal direction of the boathouse 1. The latter channels may extend from the border area 12 on one side of the boathouse 1 and over to the border area 12 on the other side of the boathouse 1.

Depending on the number and dimensions thereof, the channels could provide a complete supporting device for keeping the boathouse 1 in a distended position.

Instead of, or in addition to, air-filled channels, the supporting device of the boathouse 1 may be provided by means of mechanical supporting devices such as elastic rods of the kind that is used in so-called mountain tents. The rods may then be inserted into guides which replace or supplement said channels.

The supporting device of the boathouse 1 is preferably provided by pumping a gas, preferably air, into the boathouse 1 after it has been closed. In what follows, the gas will be referred to as air. However, it is to be emphasised that other gases than air may be used for the purpose.

Even though air that has been pumped into the boathouse 1 may inflate the boathouse 1 when the top portion 11 is made of a cloth-like material, it will normally be desirable, for practical reasons, to have additional supporting devices provided by means of said channels and/or rods, or possibly by a top portion 11 formed by a double cloth which is inflated. This is in order for the boathouse 1 not to collapse when an opening 13 in the boathouse 1 is brought from a closed position into an open position.

The protective device 1 protects the boat 16 from the elements, from contaminants like airborne particles and bird droppings and, depending on the degree of opaqueness of the top portion 11, from sunlight.

To provide a desired climate inside the protective device 1, it may be provided with, in addition to the air-supplying device 14, a ventilation device and/or an air-conditioning plant (not shown) of a kind known per se. But the air exchange which is provided in consequence of air supply and leakages out of the protective device has turned out to be favourable to the air humidity inside the closed protective device 1.

The overpressure inside the protective device 1 could also be measured by a pressure sensor which is connected to an alarm installation. When considerable pressure changes are detected while, at the same time, the alarm is activated, one or more signals will be emitted. This may be very useful in case of, for example, a burglary or by possible damage to the cloth of the boathouse 1.

The air-supplying device 14 or possibly said ventilation device could also be connected automatically to a fire retardant of a kind known per se, or be operated automatically to evacuate air which is within the protective device 1 upon the detection of smoke, heat above a predetermined level or flames.

The protective device 1 according to the present invention could be module-based. By this is meant that it could be made in sheets of cloth which may be joined by means of means known per se, such as, but not limited to, a zip fastener, a Velcro® fastener, a rail system, which could all provide a sufficiently tight joint. Thus, the protective device 1 could be adapted for boats of different sizes.

1. A protective device for a boat which is floating in water or is placed on land, the protective device including a top portion constituted by a cloth-like material which is defined by a continuous border area that is arranged to be brought into substantially sealing contact with an adjacent portion by a holding device selected from the group comprising ballast means or mechanical means, in order thereby to provide a space defined by the adjacent portion and the top portion, wherein the top portion is connected to an air-supplying device that is arranged to supply air into said space to create a higher pressure in the space than outside the space, the pressure difference created by the air-supplying device being sufficient to be able to support at least a portion of the top portion in a distended position.

2. The protective device according to claim 1, wherein the adjacent portion is formed by a water surface.

3. The protective device according to claim 1, wherein the adjacent portion is formed by a foundation carrying the boat.

4. The protective device according to claim 1, wherein the adjacent portion is formed by a portion of the boat.

5. The protective device according to claim 1, wherein the protective device includes at least one closable opening.

6. The protective device according to claim 1, wherein the top portion is further provided with several elongated channels arranged in connection with the top portion.

7. The protective device according to claim 1, wherein the top portion is further provided with a double cloth which defines one or more chambers arranged to contain the gas.

8. The protective device according to claim 7, wherein the gas is air.

9. The protective device according to claim 1, wherein the top portion is further provided with one or more mechanical supporting elements which are arranged to support at least a portion of the top portion in a distended position independently of the air that is supplied to the space by means of the air-supplying device.

10. The protective device according to claim 2, wherein the protective device is further provided with a buoyancy means.

11. The protective device according to claim 1, wherein the protective device is provided with mooring openings, so that moorings of the boat may be passed through the openings substantially independently of the protective device.

12. The protective device according to claim 2, wherein the protective device is further provided with a skirt which is arranged to hang freely from a portion of the top portion.

13. The protective device according to claim 12, wherein the skirt extends below the water surface.

14. The protective device according to claim 4, wherein the protective device is further provided with a skirt which is arranged to hang freely from a portion of the top portion.

15. A method of providing a protective device for a boat which is floating in a water or is placed on land, the protective device including a top portion which is formed by a cloth-like material which is defined by a continuous border area, the top portion being placed over at least a portion of the boat, wherein the method includes placing the border area in substantially sealing contact with an adjacent portion, wherein the method further comprising supplying air by means of an air-supplying device into a space that is defined by the adjacent portion and the top portion so that a pressure difference is created between the air within the space and the ambient pressure outside the space sufficient to support the top portion in a distended position.

16. The method according to claim 15, wherein the method further includes providing ventilation of air which is inside the protective device.

17. The method according to claim 16, wherein the method further includes connecting a fire retardant to the ventilation plant or operating the ventilation plant to evacuate air within the protective device upon the detection of smoke, heat or flames.

18. The method according to claim 16, wherein the method further includes placing a sensor arranged to detect changes in pressure inside the protective device.

19. The method according to claim 16, wherein the method further includes controlling the climate in the protective device by means of an air-conditioning plant.

20. The method according to claim 19, wherein the method further includes connecting a fire retardant to the air-conditioning plant or operating the air-conditioning plant to evacuate air within the protective device upon the detection of smoke, heat or flames.
